(19) United States
(12) Patent Application Publication
(10) Pub. No.: US 2007/0086385 A1
(43) Pub. Date: Apr. 19, 2007

(54) Method and apparatus for supporting handover in transport layer

(75) Inventors: Kyung-Joo Suh, Seoul (KR); Jae-Hee Cho, Seoul (KR); Soon-Young Yoon, Seoul (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/581,835

(22) Filed: Oct. 17, 2006

(30) Foreign Application Priority Data
Oct. 17, 2005 (KR) 2005-0097786

(51) Int. Cl. H04Q 7/00

(52) U.S. Cl. 370/331

(57) ABSTRACT

A method and apparatus of supporting a fast handover in a transport layer is provided. In a network using an SCTP (Stream Control Transmission Protocol), an MN (Mobile Node) acquires a first new IP (Internet Protocol) address after a first handover to a first new network area, stores information about the first handover to the first new network area, and sends (i.e., transmits) a first handover message including the new IP address to a CN (Correspondent Node). If a second handover to a second network area is required, the MN performs the second handover even if a response message for the first handover message has not been received, acquires a second new IP address, stores information about the second handover, and sends a second handover message including the second new IP address to the CN.

### PRIORITY

This application claims priority under 35 U.S.C. § 119 to an application filed in the Korean Intellectual Property Office on Oct. 17, 2005 and assigned Serial No. 2005-97786, the contents of which are incorporated herein by reference.

### BACKGROUND OF THE INVENTION

1. Field of the Invention

The present invention relates generally to a fast handover supporting method and apparatus, and in particular, to a method and apparatus of performing a Mobile Node's (MN's) fast handover in a transport layer.

2. Description of the Related Art

Wireless Internet connectivity based on Wireless Local Area Network (WLAN), Bluetooth, and/or infrared communications is replacing wired Internet connectivity provided in homes, offices, schools, and/or commercial environments.

As wireless communications enables mobility, specific studies have been conducted on the mobility, and the Internet technology standardization body, Internet Engineering Task Force (IETF), has presented Mobile Internet Protocol (IP) to support the mobility.

Mobile IP has been specified as Mobile IP version 4 (IPv4) and Mobile IP version 6 (IPv6) according to its versions.

Mobile IP is a network-layer protocol for supporting the mobility from a macro point of view by enabling seamless on-going communication without changing the IP address of the MN when an MN moves from one network to another during communication with a particular Correspondent Node (CN).

Mobility in the network layer is distinguished from mobility in the data link layer. Especially the data link layer-mobility, for example, in WLAN is mobility between Access Points (APs) in a data link layer protocol such as Institute of Electrical and Electronics Engineers (IEEE) 802.11a/b/g.

However, a drawback with Mobile IP is that according to its version, Mobile IP requires routers equipped with particular agent functions like a Home Agent (HA) or a Foreign Agent (FA) to support mobility across networks and performs IP tunneling and packet buffering to deliver packets to the handover MN, thus bringing about excess overhead.

Compared to Mobile IP supporting mobility in the network layer, the IETF has developed Stream Control Transmission Protocol (SCTP) and mobile SCTP (mSCTP) to support mobility in the transport layer.

Unlike Mobile IP, SCTP and mSCTP support multi-homing for transport-layer mobility. Multi-homing is a technique for using a plurality of IP addresses for one or more Network Interface Cards (NICs). That is, the use of a plurality of IP addresses is supported for an MN's handover.

Real implementation of multi-homing is relatively easy because support of the multi-homing technology at end-to-end nodes suffices without the need of a particular agent. Despite this advantage, multi-homing is now at an early developmental stage building an overall framework, with no consideration to the fast handover of the MN. The fast handover is a case of micro handover that occurs when the MN moves fast between routes with relative small coverage areas.

In case of a fast handover using the multi-homing technology, a delay can cause an interruption in communication during handover.

FIG. 1 is a block diagram illustrating a conventional transport layer handover operation.

Referring to FIG. 1, it is assumed that an MN 160 moves from a first area 110 (area 1) to a second area 120 (area 2), and then from area 2 to a third area 130 (area 3) during communication with a CN 150.

After a handover from area 1 to area 2, the MN 160 notifies the CN 150 of its new IP address by using an Address Configuration Change Chunk (ADD-IP-ASCONF) message as indicated by line A.

The ADD-IP-ASCONF message is an SCTP message used for the sending node to inform the receiving node of the sending node's new IP address.

Upon receipt of the ADD-IP-ASCONF message, the CN 150 stores the new IP address of the MN 160 and replies with an Address Configuration Change Chunk Acknowledgement (ADD-IP-ASCONF-ACK) message indicated by line B. The ADD-IP-ASCONF-ACK message is a response for the ADD-IP-ASCONF message.

As the MN 160 moves from area 2 to area 3, the MN 160 it notifies the CN 150 of its new IP address using an ADD-IP-ASCONF message as indicated by arrow C.

In case of a fast handover, the MN 160 may move to area 3 without receiving the ADD-IP-ASCONF-ACK message.

In this case, the basic handover procedure is not completed, thus interrupting communication.

For a proper completion of handover, the MN 160 has to await reception of the ADD-IP-ASCONF-ACK message in area 2 before handing off to another area. However, the resulting time delay impedes the fast handover of the MN 160. Thus, there is a need for a method which can perform a fast handover without a time delay.

### SUMMARY OF THE INVENTION

An object of the present invention is to substantially solve at least the above problems and/or disadvantages and to provide at least the advantages below. Accordingly, an object of the present invention is to provide a fast handover method and apparatus in a transport layer.

According to one aspect of the present invention, in a handover method of an MN in a network using an SCTP, the MN acquires a first new IP address after a first handover to a first new network area, stores information about the first handover to the first new network area, and sends (i.e., transmits) a first handover message including the new IP address to a CN. If a second handover to a second network area is required, the MN performs the second handover even if a response message for the first handover message has not been received, acquires a second new IP address, stores information about the second handover, and sends a second handover message including the second new IP address to the CN.

According to another aspect of the present invention, in a handover method in a CN in a network using an SCTP, the CN receives a handover message from an MN, extracts a primary IP address and a new IP address from the handover message, and generates an entry using the extracted IP addresses. The CN determines an IP address to which a response message is to be sent according to the generation order of the entry and sends the response message to the determined IP address.

According to a further aspect of the present invention, in a method of transmitting a handover response message in a CN in a network using an SCTP, the CN determines whether primary IP addresses stored in first and second entries are identical and handover indicators are set to indicate handovers in the first and second entries. If the primary IP addresses are identical and the handover indicators are set to indicate handovers, the CN determines whether the first entry is earlier than the second entry. If the first entry is earlier than the second entry, the CN determines whether an ACK indicator is set to indicate transmission of a response message in the first entry. If the ACK indicator is set to indicate transmission of a response message in the first entry, the CN sends a response message to the primary IP address and a new IP address stored in the second entry.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a conventional transport layer handover operation;

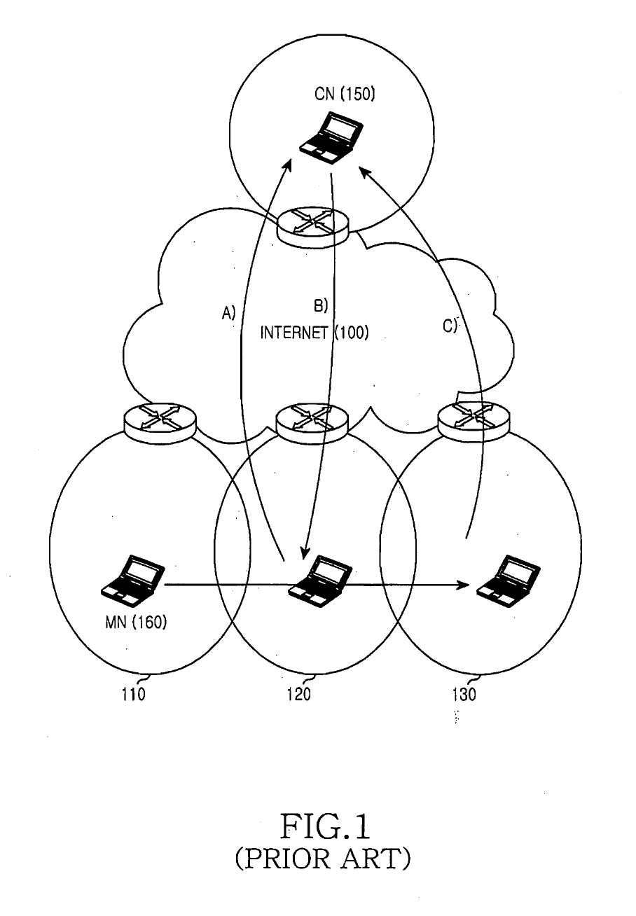

FIG. 2 is a block diagram illustrating a network configuration under a fast handover environment according to the present invention;

FIG. 3 is a table illustrating a data structure for managing a fast handover in an MN according to the present invention;

FIG. 4 is a flowchart illustrating a method for supporting mobility in the MN under a fast handover environment according to the present invention;

FIG. 5 is a table illustrating a data structure for managing the fast handover in a CN according to the present invention;

FIG. 6 is a flowchart illustrating a method for supporting mobility in the CN under the fast handover environment according to the present invention;

FIG. 7 is a table illustrating the structure of an ADD-IP-ASCONF message according to the present invention;

FIG. 8 is a table illustrating the structure of an ADD-IP-ASCONF-ACK message according to the present invention; and

FIG. 9 is a block diagram illustrating a handover operation according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provides a method of supporting a fast handover in a transport layer.

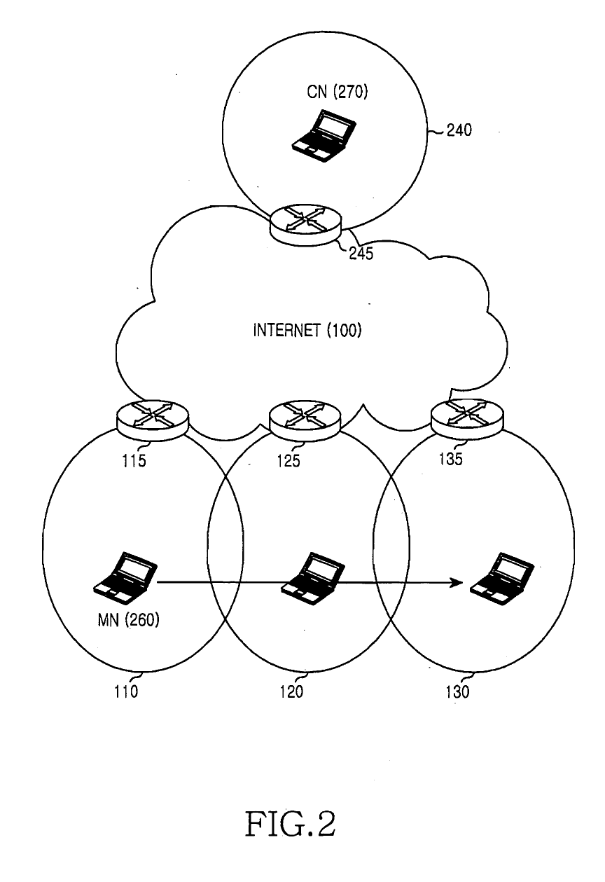

FIG. 2 is a block diagram illustrating a network configuration under a fast handover environment according to the present invention.

Referring to FIG. 2, a CN 270 being an end node communicates with an MN 260 by SCTP/IP over an Internet 100.

According to the present invention, it is assumed that the MN 260 uses a data link layer protocol (e.g., IEEE 802.11a/b/g) supporting wireless communications and routers 115, 125, 135, and 245 each are configured to have a wireless communication device (e.g. an AP supporting the IEEE 802.11a/b/g protocol) in addition to a conventional router structure and are thus capable of wireless communications. The wireless communication devices are incorporated into the routers 115, 125, 135, and 245, and/or separately implemented.

The routers 115, 125, 135, and 245 each have corresponding unique IP address ranges so that nodes connected to the routers 115, 125, 135, and 245 have unique IP addresses according to their connected routers.

In IPv4, a unique IP address is a public address, not a private address. In IPv6, it is not a local address but a global unicast address.

While not shown, the CN 270 can be connected to the router 245 by cable, instead of a wireless connection.

The routers 115, 125, 135, and 245 periodically send advertisement messages announcing their existence to nodes which want to access the routers. The advertisement messages contain the network addresses of the corresponding routers 115, 125, 135, and 245.

The advertisement messages, which are transmitted wirelessly with the network addresses of the corresponding routers 115, 125, 135 and 245, cover areas 110, 120, 130, and 240, respectively because of their radio power levels.

Nodes within the coverage areas 110, 120, 130, and 240 of the routers 115, 125, 135, and 245 can acquire IP addresses using the periodically transmitted advertisement messages.

The IP address acquisition is carried out using a Dynamic Host Configuration Protocol (DHCP) in IPv4. In IPv6, a node generates an IP address on its own or acquires an IP address by the DHCP as with IPv4. The DHCP is a protocol for allocating an IP address to a node by a router or a particular server.

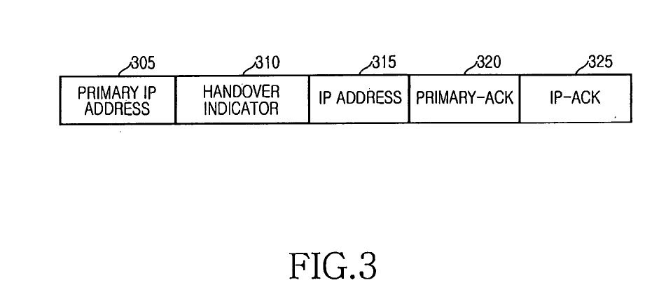

FIG. 3 is a table illustrating a data structure for managing a fast handover in the MN according to the present invention.

Referring to FIG. 3, the data structure includes a primary IP address 305, a handover indicator 310, an IP address 315, a primary-ACK 320, an IP-ACK 325.

The primary IP address 305 is a main IP address in current use for the MN 260. The handover indicator 310 indicates that the MN 260 has performed a handover. The IP address 315 is a new IP address that the MN 260 has acquired during the handover.

The primary-ACK 320 indicates whether an ADD-IP-ASCONF-ACK message has been received at the primary IP address. The IP-ACK 325 indicates whether the ADD-IP-ASCONF-ACK message has been received at the new IP address.

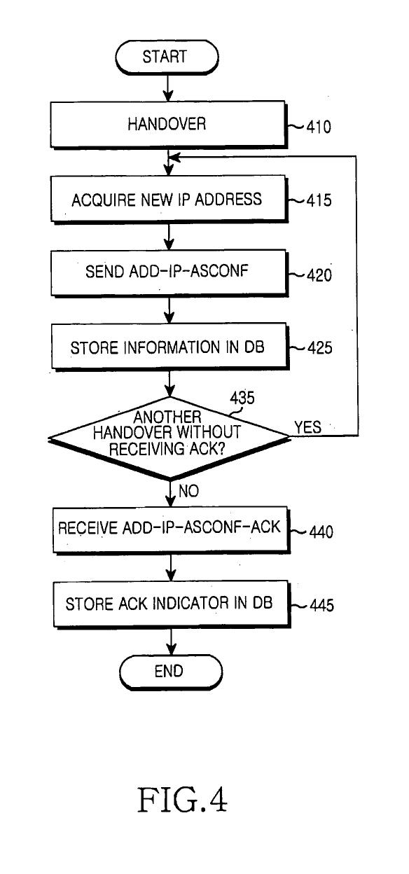

FIG. 4 is a flowchart illustrating a method for supporting mobility in the MN under a fast handover environment according to the present invention.

Referring to FIG. 4, after a handover from area 1 to area 2 in step 410, the MN 260 acquires a new IP address for area 2 in step 415.

In step 420, the MN 260 sends an ADD-IP-ASCONF message with the new IP address and a handover (H) bit set to indicate the handover to the CN 270.

The MN 260 stores its primary IP address, a handover indicator and the new IP address for area 2 in a DataBase (DB) in the format illustrated in FIG. 3 in step 425.

In step 435, the MN 260 determines whether it has moved to area 3 without receiving an ADD-IP-ASCONF-ACK message from the CN 270. Based upon the determination, the MN 260 returns to step 415 and acquires a new IP address for area 3.

Thereafter, in step 420, the MN 260 sends an ADD-IP-ASCONF message with the new IP address and an H bit set to indicate the handover to area 3 to the CN 270.

The MN 260 then stores its primary IP, the handover indictor, and the new IP address for area 3 in the DB in the format illustrated in FIG. 3 in step 425.

If the MN 260 performs no further handover in step 435, it receives an ADD-IP-ASCONF-ACK message from the CN 270 in step 440.

In step 445, the MN 260 stores information indicating the reception of the ADD-IP-ASCONF-ACK message in the DB and then ends the algorithm of the present invention.

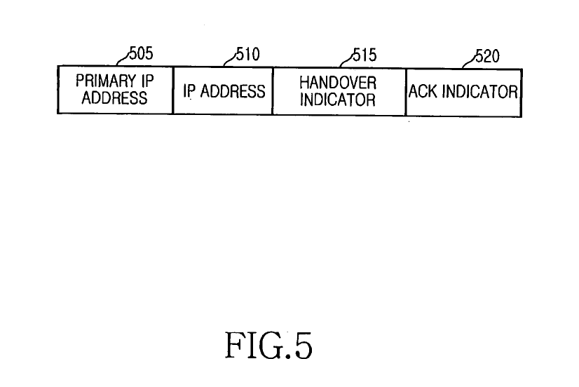

FIG. 5 is a table illustrating a data structure for managing a fast handover in the CN according to the present invention.

Referring to FIG. 5, a primary IP address 505 is the main IP address of the MN 260. An IP address 510 is a new IP address set in an ADD-IP-ASCONF message received from the MN 260, i.e., a new IP address that the MN 260 has acquired after a handover.

A handover indicator 515 indicates whether the MN 260 has performed the handover. An ACK indicator 520 indicates whether the CN 270 has sent an ADD-IP-ASCONF-ACK message to the MN 260.

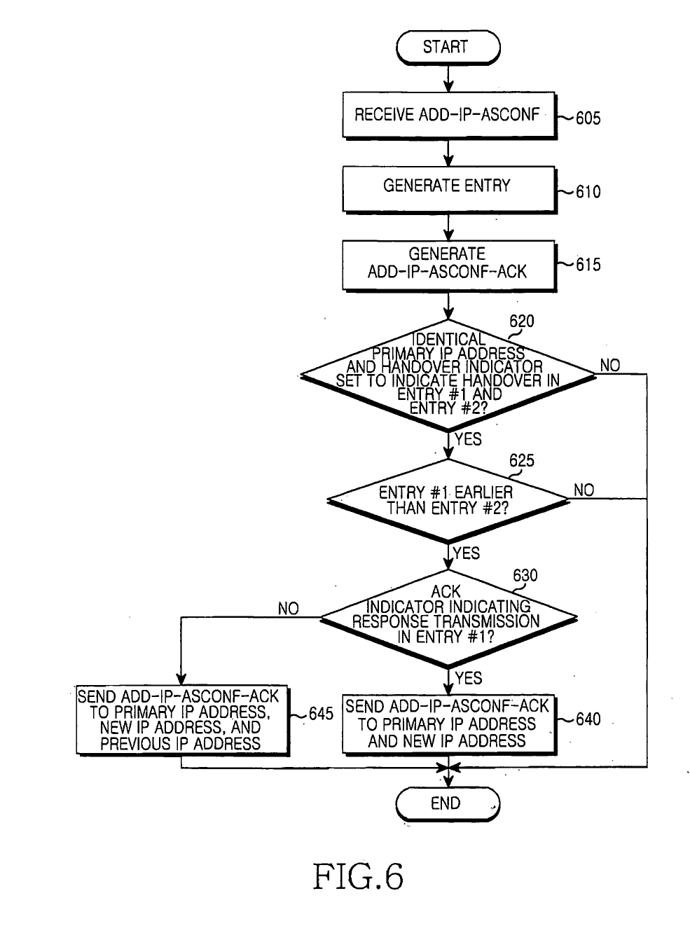

FIG. 6 is a flowchart illustrating a method for supporting mobility in the CN under the fast handover environment according to the present invention.

Referring to FIG. 6, upon receipt of an ADD-IP-ACONF message from the MN 260 in step 605, the CN 270 generates an entry in the data structure illustrated in FIG. 5, including a primary IP address and a new IP address set in the ADD-IP-ASCONF message, and a handover indicator set to indicate a handover of the MN 260, and stores the entry in a DB in step 610.

According to the present invention, it is assumed that two entries are present in the DB, entry #1 is based on an ADD-IP-ASCONF message received from the MN 260 which has performed a handover from area 1 to area 2, and entry #2 is based on an ADD-IP-ASCONF message received from the MN 260 which has performed a handover from area 2 to area 3. A new IP address that the MN 260 has acquired during the handover from area 1 to area 2 is called a previous IP address.

In step 615, the CN 270 generates an ADD-IP-ASCONF-ACK message with an H bit set to indicate handover. The CN 270 then compares entry #1 with entry #2 in step 620.

In step 620, if it is determined that entry #1 and entry #2 have the same primary IP address and handover indicators set to indicate the MN's handovers, the CN 270 continues to step 625 and determines whether entry #1 was created earlier than entry #2.

Since entry #1 includes the previous IP address and entry #2 includes the new IP address, if entry #1 is earlier than entry #2, this means that the MN 260 has moved from area 1 to area 2 first and then from area 2 to area 3.

In step 625, if it is determined that entry #1 was created earlier than entry #2, the CN 270 continues to step 630 and determines whether the ACK indicator of entry #1 is set to indicate transmission of an ADD-IP-ASCONF-ACK message.

If the ACK indicator of entry #1 is set to indicate transmission of an ADD-IP-ASCONF-ACK message which implies that the MN 260 has sent an ADD-IP-ASCONF message to the CN 270 after the handover from area 1 to area 2 and the CN 270 has replied with the ADD-IP-ASCONF-ACK message.

In step 630, if it is determined that the ACK indicator of entry #1 is set to indicate the transmission of the ADD-IP-ASCONF-ACK message in step 630, the CN 270 sends the ADD-IP-ASCONF-ACK message generated in step 615 to the primary IP address and the new IP address and then sets the ACK indicator of entry #2 to indicate the transmission of this ADD-IP-ASCONF-ACK message in step 640.

Since the MN 260 has moved from area 2 to area 3 after the handover from area 1 to area 2, the ADD-IP-ASCONF-ACK message is sent to the primary IP address and the new IP address.

On the contrary, if it is determined that the ACK indicator of entry #1 is not set to indicate the transmission of the ADD-IP-ASCONF-ACK message in step 630, the CN 270 sends the ADD-IP-ASCONF-ACK message to the primary IP address, the new IP address, and the previous IP address and then sets the ACK indicator of entry #2 to indicate the transmission of this ADD-IP-ASCONF-ACK message in step 645. The CN 270 then ends the algorithm of the present invention.

Because the MN 260 has moved from area 2 to area 3 without completing the handover from area 1 to area 2, the ADD-IP-ASCONF-ACK message is sent to the primary IP address, the new IP address, and the previous IP address.

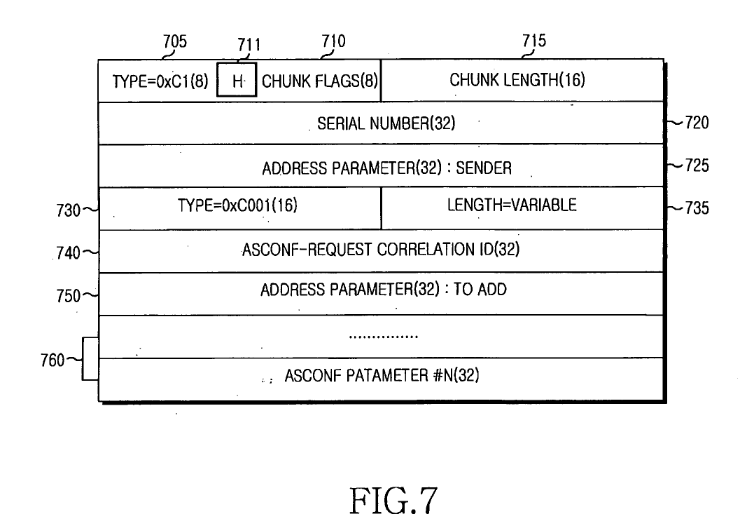

FIG. 7 is a table illustrating the structure of the ADD-IP-ASCONF message according to the present invention. The ADD-IP-ASCONF message is used to deliver a new IP address that the MN acquires after a handover to the CN. Each of specific numerals filled in the brackets denotes the size of a corresponding field in the number of bits.

Referring to FIG. 7, a Type 705 indicates the type of the message. The term used herein “Chunk” is used in the meaning of “message”. “0xC1” represents a type of an ASCONF message.

A Chunk Length 715 indicates the length of the message. A Serial Number 720 is the serial number of the message, ranging from 0 to 4294967295 (the number 2³²). An Address Parameter 725 provides the primary IP address of a sender, i.e., the MN 260.

Additional ASCONF parameters for the ADD-IP-ASCONF message are a Type 730, a Length 735, an ASCONF Request Correlation ID 740, and an Address Parameter 750.

The Type 730 indicates an ADD-IP parameter type, “0xC001”. The Length 735 indicates the length of the message. The ASCONF-Request Correlation ID 740 is set by the sender, i.e., the MN 260 to identify the request. The CN 270 uses a copy of the ASCONF-Request Correlation ID 740.

The Address Parameter 750 is represented in the form of Type/Length/Value (TLV). It provides an IP address to be added to information about the MN 260 that the CN 270 preserves. Besides the above ASCONF parameters, other ASCONF Parameters 760 may be added.

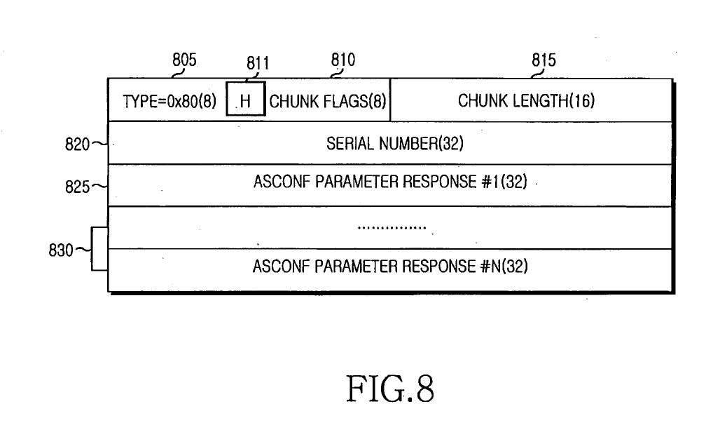

FIG. 8 is a table illustrating the structure of the ADD-IP-ASCONF-ACK message according to the present invention. The ADD-IP-ASCONF-ACK message is a response for the ADD-IP-ASCONF message. Each of specific numerals filled in the brackets denotes the size of a corresponding field in the number of bits.

Referring to FIG. 8, a Type 805 indicates the type of the message. The Type 805 is set to “0x80” to indicate that this message is the ASCONF-ACK chunk. A Chunk Flags 810 is reserved for setting a particular flag. In the present invention, one bit of the Chunk Flags 810 is used as an H bit 811 to confirm a handover. A Chunk Length 815 indicates the length of the message.

A Serial Number 820 is the serial number of the message, ranging from 0 to 4,294,967,295. An ASCONF Parameter Response 825 indicates the process status of the received ADD-IP-ASCONF message. The process status indicates error or success. Besides the ASCONF Parameter Response 825, there may be further ASCONF Parameter Responses 830.

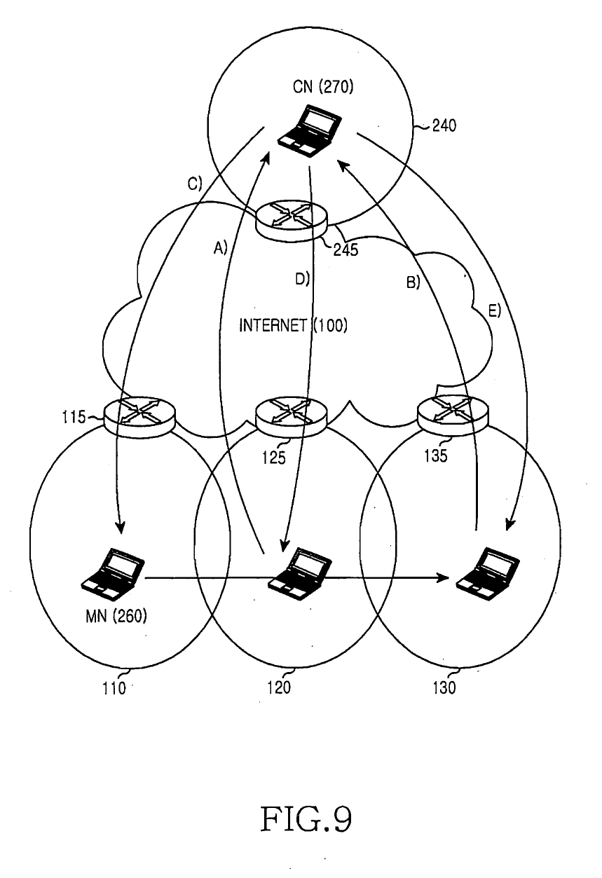

FIG. 9 is a block diagram illustrating a handover operation according to the present invention.

Referring to FIG. 9, it is assumed that the MN 260 moves from area 1 to area 2, and then from area 2 to area 3 during communication with the CN 270. An IP address that the MN 260 acquires in area 2 is called a previous IP address, and an IP address that the MN 260 acquires in area 3 is called a new IP address.

After a handover from area 1 to area 2, the MN 260 acquires the previous IP address and notifies the CN 270 of the previous IP address by an ADD-IP-ASCONF message as indicated by line AA.

Upon receipt of the ADD-IP-ASCONF message, the CN 270 creates an entry with the previous IP address set in the ADD-IP-ACONF message.

If the MN 260 moves to area 3 without receiving an ADD-IP-ASCONF ACK message from the CN 270 for the ADD-IP-ASCONF message, it sends an ADD-IP-ASCONF message including the new IP address acquired in area 3 to the CN 270 as indicated by line BB.

The CN 270 then creates an entry with the new IP address set in the ADD-IP-ASCONF message.

The CN 270 generates an the ADD-IP-ASCONF-ACK message and sends it to the primary IP address and the new IP address of the MN 260 (as indicated by lines C or E) or to the primary IP address, the previous IP address, and the new IP address of the MN 260 (as indicated by lines C, D, or E) by checking the entries according to the algorithm of FIG. 6.

As described above, the present invention provides a method of supporting a fast handover for an MN in a transport layer in order to support the mobility of the MN.

In the case where the MN performs successive handovers, the MN can perform the next handover without waiting for a response message for a transmitted message indicating the current handover from a CN and, once it acquires a new IP address during the next handover, the MN sends a message indicating the next handover to the CN. Therefore, a time delay is reduced.

In addition, since the CN sends a response message to selective destination IP addresses, the MN and the CN can minimize data loss and conduct seamless communications.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A handover method in a Mobile Node (MN) in a network using a Stream Control Transport Protocol (SCTP), comprising the steps of:
acquiring a first new Internet Protocol (IP) address after a first handover to a first new network area, storing information about the first handover to the first new network area, and transmitting a first handover message including the new IP address to a Correspondent Node (CN); and
performing a second handover to a second new network area, where the handover to the second network area is required, acquiring a second new IP address, storing information about the second handover, and transmitting a second handover message including the second new IP address to the CN.

2. The handover method of claim 1, wherein each of the information about the first handover and the information about the second handover includes a primary IP address of the MN, a handover indicator indicating the handover, the new IP address acquired after the handover, a primary ACKnowledgement (ACK) indicating whether a response message for the handover message has been received, and an IP ACK indicating whether the response message for the handover message has been received at the new IP address.

3. The handover method of claim 1, wherein each of the first and second handover messages includes a message type, handover indication information, a message length, a message sequence number, a type of the additional parameter indicating the primary IP address and the new IP address of the MN, a length of the additional parameter, and information identifying the additional parameter.

4. The handover method of claim 1, wherein a response message for the first handover message includes a message type, handover indication information, a message length, a message sequence number, and information indicating a processing result of the first handover message.

5. The handover method of claim 1, wherein the second handover is performed before receiving a response message for the first handover.

6. A handover method in a Correspondent Node (CN) in a network using a Stream Control Transport Protocol (SCTP), comprising the steps of:
receiving a handover message from a Mobile Node (MN);
extracting a primary Internet Protocol (IP) address and a new IP address from the handover message and generating an entry using the extracted IP addresses;
determining an IP address to which a response message is to be transmitted according to the generation order of the entry; and
transmitting the response message to the determined IP address.

7. The handover method of claim 6, wherein the entry includes the primary IP address set in the handover message, the new IP address that the MN has acquired after a handover, a handover indicator indicating the handover of the MN, and an ACKnowledgement (ACK) indicator indicating whether the response has been sent to the MN.

8. The handover method of claim 7, wherein the determining step comprises:
if the CN has received first and second handover messages for first and second handovers from the MN, an entry for the first handover message includes the same primary IP address as an entry for the second handover message, the entries having handover indicators set to indicate the handovers, the entry for the first handover message being created earlier than the entry for the second handover message, and an ACK indicator being set to indicate the transmission of a response message in the entry for the first handover message, setting the primary IP address of the MN and a new IP address included in the entry for the second handover message as IP addresses to which the response message for the handover message are to be transmitted.

9. The handover method of claim 7, wherein the determining step comprises:
if the CN has received first and second handover messages for first and second handovers from the MN, an entry for the first handover message has the same primary IP address as an entry for the second handover message, the entries having handover indicators set to indicate the handovers, the entry for the first handover message being created earlier than the entry for the second handover message, and an ACK indicator is not set to indicate the transmission of a response message in the entry for the first handover message, setting the primary IP address of the MN and new IP addresses included in the entries for the first and second handover messages as IP addresses to which the response message for the handover message is to be sent.

10. The handover method of claim 6, wherein the handover message includes a message type, handover indication information, a message length, a message sequence number, an additional parameter a type of the additional parameter indicating the primary IP address and the new IP address of the MN, a length of the additional parameter, and information identifying the additional parameter.

11. The handover method of claim 7, wherein the response message includes a message type, handover indication information, a message length, a message sequence number, and information indicating a processing result of the handover message.

12. A method of transmitting a handover response message in a Correspondent Node (CN) in a network using a Stream Control Transport Protocol (SCTP), comprising the steps of:
determining whether primary Internet Protocol (IP) addresses stored in first and second entries are identical and handover indicators are set to indicate handovers in the first and second entries;
determining whether the first entry is earlier than the second entry, when the primary IP addresses are identical and the handover indicators are set to indicate handovers;
determining whether an ACKnowledgement (ACK) indicator is set to indicate transmission of a response message in the first entry, when the first entry is earlier than the second entry; and
transmitting a response message to the primary IP address and a new IP address stored in the second entry, when the ACK indicator is set to indicate transmission of the response message in the first entry.

13. The method of claim 12, further comprising transmitting the response message to the primary IP address of the MN and new IP addresses stored in the first and second entries, when the ACK indicator is not set to indicate transmission of the response message in the first entry.

14. The method of claim 12, further comprising storing the primary IP address and a new IP address in an entry, upon receipt of a handover message from the MN after the MN moves to a new network by handover.

15. The method of claim 14, wherein the handover message includes a message type, handover indication information, a message length, a message sequence number, and additional parameter, a type of an additional parameter indicating the primary IP address and the new IP address of the MN, a length of the additional parameter, and information identifying the additional parameter.

16. The method of claim 12, wherein the response message includes a message type, handover indication information, a message length, a message sequence number, and information indicating a processing result of the handover message.

17. A Mobile Node (MN) in a network using a Stream Control Transport Protocol (SCTP), comprising:
means for acquiring a first new Internet Protocol (IP) address after a first handover to a first new network area;
means for storing information about the first handover to the first new network area;
means for transmitting a first handover message including the new IP address to a Correspondent Node (CN);
means for performing a second handover to a second new network area, where the handover to the second network area is required;
means for acquiring a second new IP address;
means for storing information about the second handover; and
means for transmitting a second handover message including the second new IP address to the CN.

18. A Correspondent Node (CN) in a network using a Stream Control Transport Protocol (SCTP), comprising:
means for receiving a handover message from a Mobile Node (MN);
means for extracting a primary Internet Protocol (IP) address and a new IP address from the handover message and generating an entry using the extracted IP addresses;
means for determining an IP address to which a response message is to be transmitted according to the generation order of the entry; and
means for transmitting the response message to the determined IP address.

19. A Correspondent Node (CN) in a network using a Stream Control Transport Protocol (SCTP), comprising the steps of:
means for determining whether primary Internet Protocol (IP) addresses stored in first and second entries are identical and handover indicators are set to indicate handovers in the first and second entries;
means for determining whether the first entry is earlier than the second entry, when the primary IP addresses are identical and the handover indicators are set to indicate handovers;
means for determining whether an ACKnowledgement (ACK) indicator is set to indicate transmission of a response message in the first entry, when the first entry is earlier than the second entry; and
means for transmitting a response message to the primary IP address and a new IP address stored in the second entry, when the ACK indicator is set to indicate transmission of the response message in the first entry.

20. A network using a Stream Control Transport Protocol (SCTP), comprising:
a mobile Node (MN) comprising means for acquiring a first new Internet Protocol (IP) address after a first handover to a first new network area, storing information about the first handover to the first new network area, and transmitting a first handover message including the new IP address and means for performing a second handover to a second new network area, where the handover to the second network area is required, acquiring a second new IP address, storing information about the second handover and transmitting a second handover message including the second new IP address; and
a correspondent Node (CN) comprising means for receiving a handover message from the Mobile Node (MN), means for extracting a primary Internet Protocol (IP) address and a new IP address from the handover message and generating an entry using the extracted IP addresses, means for determining an IP address to which a response message is to be transmitted according to the generation order of the entry; and means for transmitting the response message to the determined IP address.
